(19) United States
(12) Patent Application Publication
(10) Pub. No.: US 2015/0320255 A1
(43) Pub. Date: Nov. 12, 2015

(54) Vibration Monitoring System For A Liquid Food Producing Apparatus

(71) Applicants: Xingjun SHE, (US); Ruguo HU, (US); NESTEC S.A., Vevey (CH)

(72) Inventors: Xingjun SHE, Shanghai (CN); Ruguo HU, Shanghai (CN)

(73) Assignee: Nestec S.A., VEVEY (CH)

(21) Appl. No.: 14/761,447

(22) PCT Filed: Jan. 16, 2013
(86) PCT No.: PCT/CN2013/070516

§ 371 Date: Jul. 16, 2015

(51) Int. Cl. A47J 31/44; G01H 3/00

(52) U.S. Cl. CPC A47J 31/44; G01H 3/00

(57) ABSTRACT

A vibration monitoring system (109) for a liquid food producing apparatus, comprising:
data storage means (130) storing nominal vibration data (170), said nominal vibration data representing the nominal vibration performance of the liquid food producing apparatus;
data acquisition means (110) acquiring acquired vibration data (160), said acquired vibration data pertaining to the vibration of the liquid food producing apparatus while functioning;
data processing means (120) processing said acquired vibration data (160) into at least processed vibration data (165), said processed vibration data being of a similar format than the nominal vibration data (170);
data comparison means (140) yielding a comparison information (175) representative of the comparison of said processed vibration data (165) and said nominal vibration data (170); and
display means (155), or display connection means for connecting display means, for displaying said comparison information (175) and/or information issued from said comparison information (175).

### CROSS REFERENCE TO RELATED APPLICATIONS/INCORPORATION BY REFERENCE STATEMENT

This application is a US national stage application filed under 35 USC §371 of International Application No. PCT/CN2013/070516, filed Jan. 16, 2013. The entire contents of the above-referenced application are hereby expressly incorporated herein by reference.

### BACKGROUND

The presently disclosed and/or claimed inventive concept(s) relates to vibration monitoring systems. In particular, the presently disclosed and/or claimed inventive concept(s) relates to a vibration monitoring system for a liquid food producing apparatus.

Any user of a liquid food producing apparatus, whether it be a consumer or the person responsible for the maintenance of said apparatus, can be interested in monitoring the performance of his/her product in order to know if it is functioning properly as intended.

Should the user be a consumer who has no interest in monitoring, he or she might be aware of an unusual noise during the use of the apparatus, sense unusual vibrations, and therefore be led to wondering about the performance of his/her apparatus.

Moreover, said consumer might also be aware of the altered taste or texture of the dispensed liquid food (e.g. coffee, tea, milk, etc.) caused by a decrease of the performance of the apparatus.

In such cases, the consumer might then be wrongly disappointed with the ingredients of the liquid food itself (e.g. coffee beans), rather than perform maintenance (repairing or cleaning) on the machine.

Therefore, there is a need for the user of a liquid food producing apparatus to be able to check its performance.

However, lacking specific knowledge of the apparatus, most users are unable to detect the cause of a potential underperformance or a failure of the apparatus.

In addition, it is far too complex for a user to check every parameter (e.g. temperature of the liquid, liquid extraction time, machine noise, machine vibration . . . ) that may identify faulty or altered working conditions.

Indeed, such parameters may be induced by a plurality of factors. In particular, those conditions include both interior and exterior factors.

External factors may include the quality of the power supply to the machine (voltage value, available power, current stability, etc.), the surface on which the machine is placed on, how such a surface may be affixed to another surface, the angle with which the machine is placed on said surface, any interference (electrical, magnetic . . . ) that may affect the machine, outside temperature, etc.

Internal factors may include any fault or deterioration affecting the machine's mechanical structure, such as its faults or deterioration related to the components and/or the fluid circuit, such as the pump or heater working performance, the liquid flow, the pressure of the liquid, the relative distance between the parts, the assembly or connection of the parts and so on.

It has been found that the vibration performance of a liquid food producing apparatus is influenced by the above factors and can therefore be considered representative of the machine working conditions.

Consequently, a consumer, a service engineer, or any person responsible for the maintenance of a liquid food producing apparatus, may greatly benefit from being able to monitor its vibration performance.

Some vibration monitoring systems are already disclosed by the prior art.

For example patent documents CN201707124, CN101950033, CN201788581 and CN107975608 disclose vibration monitoring systems.

However, none of these documents concern a vibration monitoring system for a liquid food producing apparatus.

More specifically, the systems disclosed by documents CN101950033 and CN201788581 concern large-sized buildings (factories, bridges, dams . . . etc), the one disclosed by CN201707124 concerns heavy equipment such as power systems, and the vibration monitoring system disclosed by document CN101795608 concerns a blasting procedure.

Thus, the presently disclosed and/or claimed inventive concept(s) seeks to provide a vibration monitoring system for a liquid food producing apparatus that will allow a user to monitor its vibration performance.

### BRIEF DESCRIPTION OF THE DRAWINGS

In the accompanying drawings, given by way of non-limiting examples:

FIG. 1 depicts a sketch of some of the units of a liquid food producing apparatus and of a vibration monitoring system according to a first embodiment;

FIG. 2 depicts a sketch of a vibration monitoring system according to the first embodiment;

FIG. 3 depicts a sketch of some of the units of a liquid food apparatus and of an associated vibration monitoring system according to a second embodiment.

FIG. 4 depicts a sketch of a vibration monitoring system according to the second embodiment;

FIG. 5 depicts a sketch of a vibration monitoring system according to a third embodiment;

FIG. 6 depicts a sketch of a vibration monitoring system according to the third embodiment;

FIG. 7 depicts a smartphone screen displaying an alert message sent by a vibration monitoring system according to the third embodiment.

### DETAILED DESCRIPTION

The presently disclosed and/or claimed inventive concept(s) is directed to a vibration monitoring system for a liquid food producing apparatus that will allow a user to monitor its vibration performance.

In a non-limiting embodiment of the presently disclosed and/or claimed inventive concept(s), a vibration monitoring system for a liquid food producing apparatus is disclosed. The system includes data storage means storing nominal vibration data, said nominal vibration data representing the nominal vibration performance of the liquid food producing apparatus. The system further includes data acquisition means acquiring acquired vibration data, said acquired vibration data pertaining to the vibration of the liquid food producing apparatus while functioning. The system also includes data processing means processing said acquired vibration data into at least processed vibration data, said processed vibration data being of a similar format than the nominal vibration data. The system also includes data comparison means yielding a comparison information representative of the comparison of said processed vibration data and said nominal vibration data. In addition, the system includes display means, or display connection means for connecting display means, for displaying said comparison information and/or information issued from said comparison information.

Thanks to the vibration monitoring system according to the present disclosure, a user may consult the display means in order to analyze the current performance of his/her machine.

Information issued from the comparison information may be, for instance, a diagnosis report or an alert message informing the user or maintenance person of a status of the liquid food producing apparatus.

Said diagnosis reports or alert messages are detailed below.

The display means can be an integral part of a liquid food producing apparatus or be a connected mobile device such as a smartphone, a portable computer, a tablet and the like.

The display connection means can be, for instance, a display docking station, a display port (e.g., USB, Ethernet, PDMI) or a wireless connection (Wifi, wDP) connectable with or provided in the food producing apparatus.

According to a particular, non-limiting embodiment, the vibration monitoring system further comprises analyzing means analyzing said comparison information in order to yield a diagnosis report, said diagnosis report identifying a cause of a discrepancy between said processed vibration data and said nominal vibration data.

Specifically, the cause of discrepancies can be either an external factor or an internal factor such as the ones described hereinbefore.

The diagnosis report might also comprise an explanation as to why the apparatus is underperforming.

In a particular embodiment, the display means further display an alert message based upon said diagnosis report.

Such a report might help a consumer who has no need for precise technical information to know whether the apparatus is functioning as intended or not.

The diagnosis report may also comprise instructions on the actions a consumer should take, such as cleaning a liquid container, descaling a filter or fluid circuit, replacing spare parts, contacting a maintenance service and so on.

In order to make the vibration monitoring system accurate and economical to produce, the data acquisition means comprise an accelerometer. The accelerometer is, in a particular, non-limiting embodiment, a two- or three-dimensional accelerometer.

In a particular non-limiting embodiment, the vibration monitoring system further comprises communication means with a distant server.

The vibration monitoring system can therefore have access to any available data on the server that can be relevant for the monitoring of the apparatus.

For instance, in a particular non-limiting embodiment, the communication means comprises downloading means downloading said nominal vibration data from said distant server.

Thanks to this, there is no need for the storage means to have a high storage capability to store all the nominal vibration data.

The vibration monitoring system can therefore be lighter, cheaper and smaller.

In addition, should the nominal vibration data change after the vibration monitoring system has been installed in an apparatus, there is no need to update any data contained within the apparatus.

This is particularly useful should the nominal properties of an apparatus model change after an improvement has been made.

In a particular embodiment, the data storage means, the data processing means, and the data comparison means are comprised within a distant server, the vibration monitoring system further comprising uploading means uploading said acquired vibration data to the distant server and downloading means downloading said comparison information from the distant server to the display means.

The parts of the vibration monitoring system installed in the apparatus can therefore be lighter, cheaper and smaller.

This allows for the data processing means to be contained at a distance from the rest of the means constituting the vibration monitoring system.

For example, this allows for the data processing means to be contained within a distant server or another apparatus rather than the liquid food producing apparatus itself.

This way, older apparatuses that are not equipped with all the means constituting the vibration monitoring, are monitored as well.

In another non-limiting embodiment of the presently disclosed and/or claims inventive concept(s), there is provided a liquid food producing apparatus comprising a vibration monitoring system according to the present disclosure.

In a particular non-limiting embodiment, the data storage means of said liquid food producing apparatus comprise a memory chip comprising the nominal vibration data.

In a particular non-limiting embodiment, the display means of said liquid food producing apparatus comprise a digital screen installed on said liquid food producing apparatus.

The user therefore has a clear and simple access to the displayed information.

The digital screen may be placed upon any external surface of the liquid food producing apparatus.

In a particular non-limiting embodiment, the processing means of said liquid food producing apparatus are contained within a printed circuit board assembly of the apparatus.

Such a liquid food producing apparatus therefore contains a “built-in” vibration monitoring system that can be made independent of any external apparatus.

In another non-limiting embodiment of the presently disclosed and/or claimed inventive concept(s), there is provided a connected mobile device as part of or comprising a vibration monitoring system according to the present disclosure.

Typically, such a connected mobile device is a smartphone, a tablet or a portable computer.

In this case, the user has access to the monitoring information through a device that he or she is familiar with.

In addition, the vibration monitoring system can take advantage of the built-in functionalities of the connected mobile device.

Moreover, this enables apparatuses that have not yet been equipped (e.g. older models) with a built-in vibration monitoring system or means of this vibration monitoring system to benefit from the vibration monitoring system.

According to this particular aspect, a liquid food producing apparatus has no need to comprise any additional component.

In yet another non-limiting embodiment of the presently disclosed and/or claimed inventive concept(s), a connected mobile device according the present disclosure is provided that is configured to comprise said data acquisition means, said data processing means, said data comparison means, and said display means.

In yet another non-limiting embodiment of the presently disclosed and/or claimed inventive concept(s), a method for monitoring the vibration of a liquid food producing apparatus is provided. The method comprises the steps of: storing nominal vibration data, said nominal vibration data representing the nominal vibration performance of the liquid food producing apparatus; acquiring acquired vibration data, said acquired vibration data pertaining to the vibration of the liquid food producing apparatus while functioning; processing said acquired vibration data into at least processed vibration data, said processed vibration data being of a similar format than the nominal vibration data; yielding comparison information representative of the comparison of said processed vibration data and said nominal vibration data; and displaying or connecting display means, for displaying said comparison information and/or information issued from said comparison information.

Any reference to prior art documents in this specification is not to be considered an admission that such prior art is widely known or forms part of the common general knowledge in the field.

As used in this specification, the words “comprises”, “comprising”, and similar words, are not to be interpreted in an exclusive or exhaustive sense. In other words, they are intended to mean “including, but not limited to.”

Although the presently disclosed and/or claimed inventive concept(s) has been described by way of example, it should be appreciated that variations and modifications may be made without departing from the scope of the presently disclosed and/or claimed inventive concept(s) as defined in the claims.

Furthermore, where known equivalents exist to specific features, such equivalents are incorporated as if specifically referred in this specification.

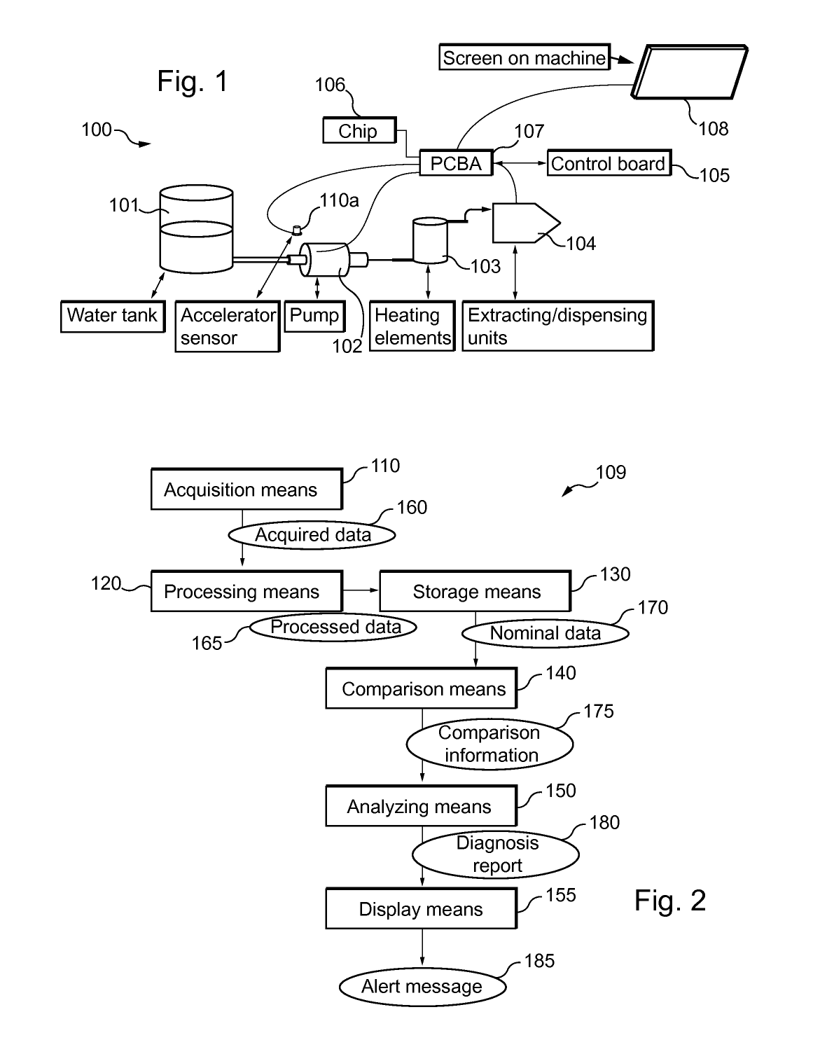

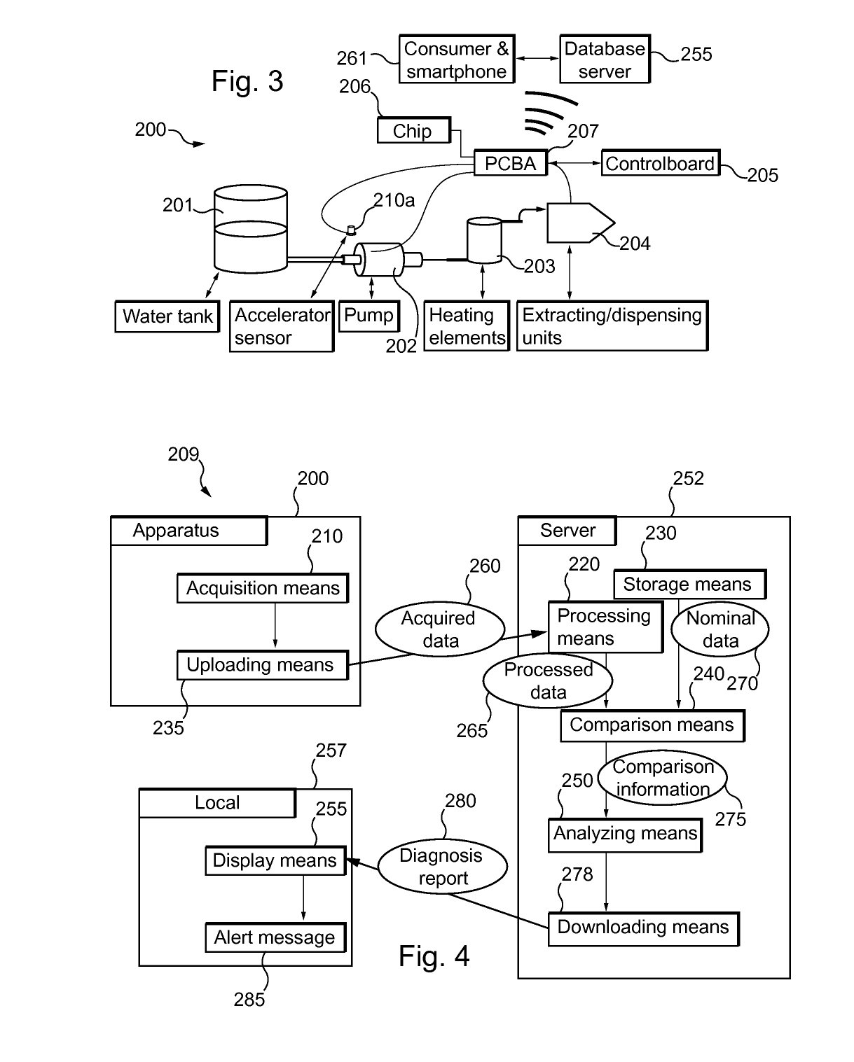

According to a first embodiment, a liquid food producing apparatus, for example a coffee machine 100 comprises a water tank 101, a pump 102, heating elements 103, extracting units 104, a control board 105, a memory chip 106, a printed circuit board assembly (PCBA) 107 and a digital screen 108 as shown on FIG. 1.

In this particular embodiment, coffee machine 100 comprises a vibration performance vibration monitoring system 109 comprising acquisition means 110, processing means 120, storage means 130, comparison means 140, analyzing means 150 and display means 155 as shown on FIG. 2.

Acquisition means 110 can be a one-dimensional, a two-dimensional or a three-dimensional accelerometer (not shown) that comprises itself a sensor 110a that is placed upon a vibration generating unit such as pump 102.

In a particular non-limiting embodiment, a three-dimensional accelerometer is used in order to obtain more data.

It should be noted that sensor 110a may be placed upon other units such as the heating elements 104 or extracting units 105.

A three-dimensional accelerometer acquires measurements in three different directions, and therefore yields more values, which in turn can give more material to analyzing means 140.

Acquired vibration data 160 can take the form of a series of measurements (frequencies or amplitude) acquired over time.

In the present case, acquired vibration data 160 corresponds to the vibration force obtained through sensor 110b over a certain period of time, in three different directions.

Specifically, the acquisition time spans from when pump 103 begins functioning to the stabilization of the liquid flow rate.

For coffee machine 100, this corresponds to a 10-second span starting 10 seconds from the beginning of the extraction phase, i.e. when extracting units 104 begin functioning.

In this embodiment, acquisition means 110, can either function automatically and periodically or based on a request from the user.

Once the acquisition is over, acquired vibration data 160 is then processed by processing means 120.

In the present embodiment, processing means 120 are contained within PCBA 108 which receive the acquired vibration data 160 provided by accelerometer 110b.

Processing means 120 process said acquired vibration data 160 and yield processed vibration data 165 that is of the same format as nominal vibration data 170 that is being stored within storage means 130.

Storage means 130 contains data representing the nominal vibration performance of a machine, or nominal vibration data 170.

To be more precise, nominal vibration data corresponds to the vibration data acquired from an apparatus of the same model as the monitored apparatus as it leaves the factory.

Said nominal vibration data can be acquired by an accelerometer at the factory site. It typically comprises a series of vibration force measurements over time. Of course, the nominal vibration data may be acquired directly from a data base comprising stored data related to the relevant apparatus.

Nominal vibration data 170 typically comprises the curve of the vibration force over the 10-second acquisition span for a machine at the factory gate.

In addition, nominal vibration data 170 may include the following parameters for a machine at the gate of the factory:
the maximum vibration force, that is the peak of vibration of the curve,
the time corresponding to the force peak;
the time period over which the force peak lasts;
the distribution of the vibration force at different frequencies.
Storage means 130 are contained within memory chip 106.

However, in another embodiment, storage means 130 can also be contained within the built-in memory PCBA 108.

In yet another embodiment, storage means 130 are contained within the database of a distant server (not shown).

In such a case, vibration monitoring system 109 further comprises communication means (not shown) that download nominal vibration data 170 from the distant server.

Such communication means can be installed within coffee machine 100 and be operated by PCBA 107.

Since processed vibration data 165 has the same format as nominal data 170, it also typically comprises the curve of the vibration force over the 10-second acquisition span and can also include the following parameters for coffee machine 100:
the maximum vibration force, that is the peak of vibration of the curve,
the time corresponding to the force peak;
the time period over which the force peak lasts;
the distribution of the vibration force at different frequencies.

Processed vibration data 165 is also stored within storage means 130.

However, in another possible embodiment, processed vibration data 165 is directly sent to comparison means 140 which are hosted within PCBA 107.

Having both processed vibration data 165 and nominal vibration data 170 at its disposal within storage means 130, comparison means 140 contained within PCBA 108, may proceed to comparing processed vibration data 165 to nominal vibration data 170.

Specifically, the vibration force peak, the time corresponding to the force peak, the time period over which the force peak lasts and the distribution of the vibration force at different frequencies between the processed vibration data 165 and the nominal vibration data 170 may be compared.

In addition, the distribution of the vibration force at different frequencies may also be compared.

Comparison means 140 yield comparison information 175 representative of the comparison of said processed vibration data 165 and said nominal vibration data 170.

For example, comparison information 175 may be an adjacent display of the raw processed vibration data 165 and nominal vibration data 170.

Alternatively, the potential discrepancies between nominal vibration data 170 and processed vibration data 165 may be also provided by comparison information 175.

Comparison information 175 is further analyzed by analyzing means 150 in order to identify a possible cause of said potential discrepancies.

For example, should the force peak of the processed vibration data 165 appear at a different frequency than the force peak of the nominal vibration data 170, analyzing means 150 are able to identify whether the cause is an external or an internal factor, and the potentially affected units.

Analyzing means 150 then yield a diagnosis report 180 identifying the cause of the discrepancy between processed vibration data 165 and nominal vibration data 170.

If no discrepancy has been found, or if such a discrepancy is considered within an acceptable margin, or within a margin of error associated with acquisition or calculation, the diagnosis report 180 will reflect it.

The display means 155, comprised within digital screen 108, then display an alert message 185 to be read or seen by the user (a consumer or maintenance personnel). Alert message 185 is based upon diagnosis report 180. It can take many different forms.

Should no discrepancy be found between processed vibration 165 and nominal vibration data 170, alert message 185 may be a written message such as “OK” or “N/A”.

Alternatively, alert message 185 can take the form a pictogram that would represent the fact that coffee machine 100 has no identified problem.

In yet another alternative, alert message 185 can be a simple colorization of digital screen 108, which can for example turn green.

If diagnosis report 180 has identified the cause of a discrepancy between processed vibration data 165 and nominal vibration data 170, alert message 185 will inform the user of the cause.

If the cause is a faulty unit, alert message 185 can either state the name of the faulty unit or represent it through a drawing or a pictogram displayed upon screen 108.

If the cause is a lack of maintenance, or an external factor, alert message 185 can also reflect this.

In addition, alert message 185 can further comprise instructions on what actions a user should take in order to perform maintenance on the liquid food machine.

These instructions can take the form of a text message or a pictogram illustrating the action to take.

The actions to take can for example consist in cleaning the liquid container, descaling a filter, cleaning parts of coffee machine 100, removing foreign objects, etc.

Another action to take may also consist in contacting a consumer maintenance service should the user be a consumer.

Alternatively, according to a second embodiment, vibration monitoring system comprises 109, in replacement of display means, display connection means that allow coffee machine 100 to connect to an external device that itself comprises display means.

Such an external device typically is a connected mobile device, for instance, a smartphone, a portable computer, a tablet and the like.

The display connection means can be, for instance, a display docking station, a display port (e.g., USB, Ethernet, PDMI) or a wireless connection (Wifi, wDP) connectable with or provided in the food producing apparatus.

Comparison information or alert messages are displayed upon the display means of the external device.

According to a third embodiment, a liquid food producing apparatus, for example a coffee machine 200 comprises a water tank 201, a pump 202, heating elements 203, extracting units 204, a control board 205, a memory chip 206 and a printed circuit board assembly (PCBA) 207 as shown on FIG. 3.

In this particular embodiment, a vibration monitoring system 209 comprises acquisition means 210 and uploading means 235 placed within a coffee machine 200.

Vibration monitoring system 209 further comprises processing means 220, storage means 230, comparison means 240, analysis means 250 contained within a distant server 252.

Vibration monitoring system 209 further comprises display means 255 on a local server 257.

Acquisition means 210, which have the same function as in the first embodiment, can either function automatically and periodically or based on a request from the user or distant server 252.

However, in this embodiment, coffee machine 200 uploads the acquired vibration data 260 to distant server 252 through uploading means 235.

Uploading means 235 can be any communication means with a remote device, e.g. a built-in modem, an antenna, Bluetooth Wi-Fi, GPRS connecting means, etc.

Acquired vibration data 260 is sent to processing means 220 situated in distant server 252.

Much like in the first embodiment, processing means 220 process acquired vibration data 260 into processed vibration data 265.

Processed vibration data 265 is of the same format as nominal vibration data 270 that is stored within storage means 230.

Typically, storage means 260 is a Web-based or server-hosted database.

Nominal vibration data 270 and processed vibration data 265 are sent to comparison means 240, which take the form of analyzing software.

Comparison means 240 compare processed vibration data 265 and nominal vibration data 270 the same way as in the first embodiment and yields comparison information 275.

Comparison information 275 is further analyzed by analysis means 250 which have the same function as in the first embodiment.

Vibration monitoring system 209 further comprises downloading means 278 which are part of distant server 255.

Downloading means 278 will send a diagnosis report 280, for example through the use of emails, short messages, phone calls or the like, to local server 257.

Local server 257 typically is the user's computer or smartphone, or any connected device that can receive diagnosis report 280.

Through display means 255, the user can receive an alert message 285 similar to the one that has been described in the first embodiment.

In this third embodiment, display means 255 are the screen of the smartphone or the computer constituting local server 257.

It should be noted that in another possible embodiment, comparison information 275 is directly sent by downloading means 278 to the local server 257 and displayed by display means 255.

According to a fourth embodiment (not shown), the local server is the liquid food producing apparatus, the vibration monitoring system being otherwise the same as in the third embodiment.

In this particular embodiment, the liquid food producing apparatus comprises display means such as a digital screen placed upon the surface of the apparatus, for instance a digital screen placed on the surface of a coffee machine as shown in the first embodiment.

Comparison information or alert messages are then displayed upon said digital screen.

According to a fifth embodiment (not shown), the vibration monitoring system comprises, in replacement of display means, display connection means that allow the food producing apparatus to connect to an external device that itself comprises display means, the vibration monitoring system being otherwise the same as in the fourth embodiment.

Such an external device typically is a connected mobile device, for instance, a smartphone, a portable computer, a tablet and the like.

The display connection means can be, for instance, a display docking station, a display port (e.g., USB, Ethernet, PDMI) or a wireless connection (Wifi, wDP) connectable with or provided in the food producing apparatus.

Comparison information or alert messages are then displayed upon the display means of the external device.

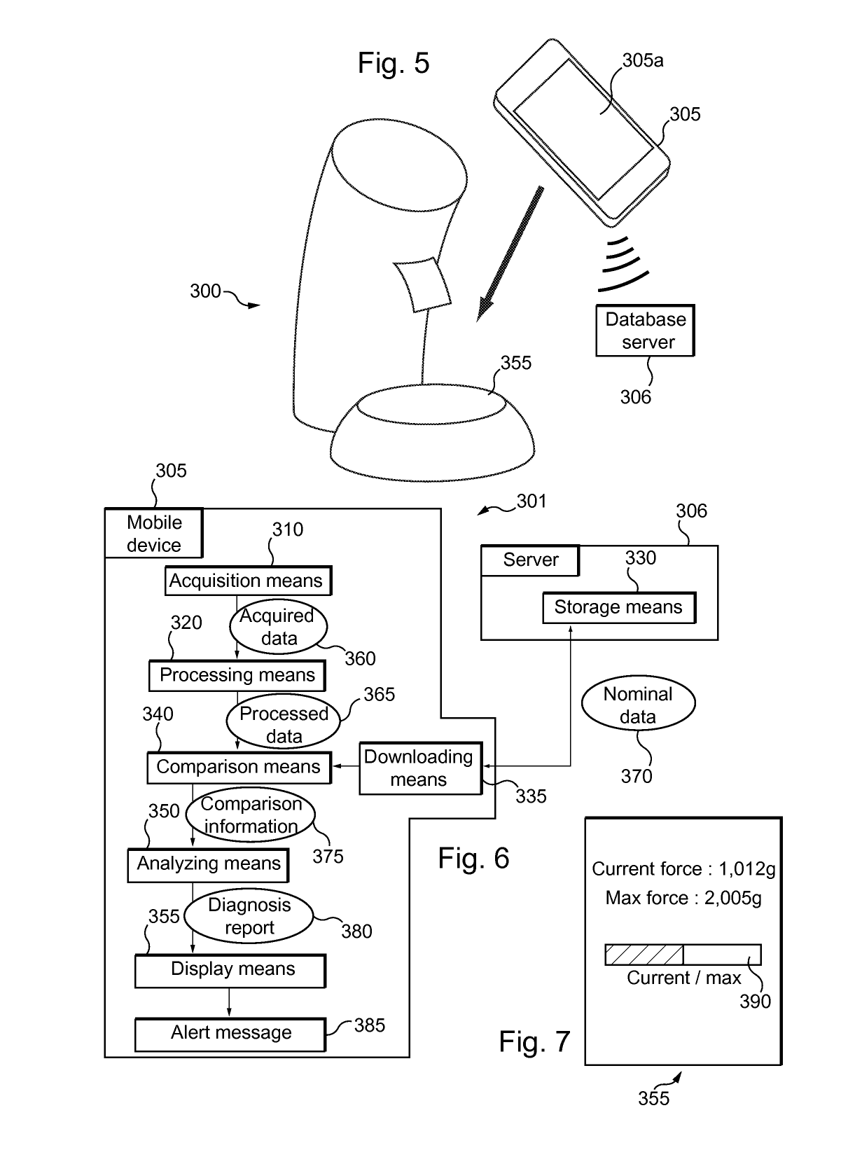

According to a sixth embodiment shown on FIGS. 5 and 6, the vibration of a coffee machine 300 is monitored by a vibration monitoring system 301 hosted by both a connected mobile device 305 and a distant server (database server) 306.

Typically, the mobile connected device 300 is a smartphone while distant server 306 can be accessed through the Web. Distant server 306 is a computer or a web page.

Vibration monitoring system 301 comprises acquisition means 310, and processing means 320 contained within mobile connected device 300.

Vibration monitoring system 301 also comprises storage means 330 contained within distant server 306.

Vibration monitoring system 301 also comprises downloading means 335, comparison means 340, analysis means 350 and display means 355 that are all contained within mobile connected device 305.

In this embodiment, mobile connected device 300 possesses acquisition means 310 in the form of an embedded accelerometer and gyroscope.

To monitor the performance of coffee machine 310, the user would be guided to put the smartphone on a specified position 355 on coffee machine 310, as shown on FIG. 5.

The user would then run coffee machine, while acquisition means 310 proceed to acquiring acquired vibration data 360 the same way as in the first embodiment.

In this particular embodiment, the vibration forces would be acquired in the three axes of the gyroscope.

Processing means 320, which in this embodiment take the form of the internal processor of the mobile connected device 300, process said acquired vibration data 360 into processed vibration data 365 the same way is in the first embodiment.

Such processed vibration data 365 is then sent to comparison means 340.

Downloading means 335 download nominal vibration data 370 from storage means 330 of distant server 306.

Storage means 330 are, in this third embodiment, a database comprising the nominal vibration data 370.

Such a database can be updated anytime should the nominal vibration data 370 change.

In this particular embodiment, downloading means 335 are the ones installed within the smartphone for communication with a remote device, e.g. a built-in modem, an antenna, Bluetooth Wi-Fi, GPRS connecting means, etc.

Once downloaded by downloading means 335, nominal vibration data 370 is also sent to comparison means 340.

Comparison means 340, also contained within the internal processor of the connected mobile device 300, then compare processed vibration data 365 and nominal vibration data 370 the same way as in the first embodiment.

Comparison information 375 is then sent to analyzing means 350 which also yield a diagnosis report 380 which is similar to what has been described in the first embodiment.

An alert message 385 based upon diagnosis report 380 is then displayed by display means 350, i.e. the smartphone screen 305a as shown on FIG. 5.

It should be noted that in another embodiment, comparison information 375 is directly displayed by display means 350.

As illustrated on FIG. 7, in a particular embodiment, alert message 385 takes the form of a filling bar 390, where a full bar means the acquired vibration force is equal to the nominal maximum vibration force.

The user would then deduce that his coffee machine is functioning in a satisfactory way as long as such a ratio is not too low.

1. A vibration monitoring system for a liquid food producing apparatus, comprising:
data storage means storing nominal vibration data, said nominal vibration data representing the nominal vibration performance of the liquid food producing apparatus;
data acquisition means acquiring acquired vibration data, said acquired vibration data pertaining to the vibration of the liquid food producing apparatus while functioning;
data processing means processing said acquired vibration data into at least processed vibration data, said processed vibration data being of a similar format than the nominal vibration data;
data comparison means yielding a comparison information representative of the comparison of said processed vibration data and said nominal vibration data; and
display means, or display connection means for connecting display means, for displaying said comparison information and/or information issued from said comparison information.

2. The vibration monitoring system according to claim 1, wherein it further comprises analyzing means analyzing said comparison information in order to yield a diagnosis report, said diagnosis report identifying a cause of a discrepancy between said processed vibration data and said nominal vibration data.

3. The vibration monitoring system according to claim 2, wherein the display means further display an alert message based upon said diagnosis report.

4. The vibration monitoring system according to claim 1, wherein the data acquisition means comprises an accelerometer.

5. The vibration monitoring system according to claim 1, wherein it further comprises communication means with a distant server.

6. The vibration monitoring system according to claim 5, wherein the communication means comprises downloading means downloading said nominal vibration data from said distant server.

7. The vibration monitoring system according to claim 5, wherein the data storage means, the data processing means, and the data comparison means are comprised within said distant server, the vibration monitoring system further comprising uploading means uploading said acquired vibration data to the distant server and downloading means downloading said comparison information from said distant server to the display means.

8. A liquid food producing apparatus comprising a vibration monitoring system according to claim 1.

9. The liquid food producing apparatus according to claim 8, wherein the display means comprise a digital screen installed on said liquid food producing apparatus.

10. A connected mobile device as part of or comprising a vibration monitoring system according to claim 1.

11. The connected mobile device according to claim 10, wherein the connected mobile device is configured to comprise:
said data acquisition means,
said data processing means;
said data comparison means; and
said display means.

12. A method for monitoring the vibration of a liquid food producing apparatus, comprising the steps of:
storing nominal vibration data, said nominal vibration data representing the nominal vibration performance of the liquid food producing apparatus;
acquiring acquired vibration data, said acquired vibration data pertaining to the vibration of the liquid food producing apparatus while functioning;
processing said acquired vibration data into at least processed vibration data, said processed vibration data being of a similar format than the nominal vibration data;
yielding comparison information representative of the comparison of said processed vibration data and said nominal vibration data; and
displaying, or connecting display means, for displaying said comparison information and/or information issued from said comparison information.
